(19) United States
(12) Patent Application Publication
(10) Pub. No.: US 2022/0164876 A1
(43) Pub. Date: May 26, 2022

(54) METHODS AND SYSTEMS FOR CREDIT RISK ASSESSMENT FOR USED VEHICLE FINANCING

(71) Applicant: SANDEEP AGGARWAL, GURGAON (IN)

(72) Inventor: SANDEEP AGGARWAL, GURGAON (IN)

(21) Appl. No.: 17/510,398

(22) Filed: Oct. 26, 2021

Related U.S. Application Data
(63) Continuation-in-part of application No. 17/033,890, filed on Sep. 27, 2020, now abandoned.
(60) Provisional application No. 62/906,098, filed on Sep. 26, 2019.
(60) Provisional application No. 62/906,099, filed on Sep. 26, 2019.

(51) Int. Cl. G06Q 40/02; G06Q 30/02

(52) U.S. Cl. CPC G06Q 40/025; G06Q 30/0206

(57) ABSTRACT

A method for implementing a credit risk assessment for used vehicle financing comprising: identifying a set of distinct factors of the vehicle, wherein the set of distinct factors are used to assess the credit worthiness of a transaction; grouping distinct factors of the vehicle into a bucket, wherein each bucket further roles up to group; determining a weighted average of the score of rules defines the score of the bucket; determining a weighted average of a score of bucket; defining the score of Group; calculating an overall score of the transaction; enabling a lender to implement specified combinations of overall scores and select a score; and fixing a risk appetite at any level.

### CLAIM OF PRIORITY

This application claim priority to and is a continuation in party of U.S. patent application Ser. No. 17/033,890, filed on Sep. 27, 2020, and titled METHODS AND SYSTEMS FOR CREDIT RISK ASSESSMENT FOR USED VEHICLE FINANCING. U.S. patent application Ser. No. 17/033,890 claims priority to U.S. Provisional Patent Application No. 62/906,098, filed on Sep. 2, 2019, and titled CREDIT RISK ASSESSMENT FOR USED VEHICLE FINANCING. U.S. patent application Ser. No. 17/033,890 claims priority to U.S. Provisional Patent Application No. 62/906,099, filed on Sep. 26, 2019, and titled AUTOMATED DEALS EVALUATION AND MANAGEMENT PLATFORM. These applications are hereby incorporate by reference in their entirety.

### BACKGROUND

Generally, when someone wishes to purchase a used vehicle (e.g. an automobile, etc.), the user can seek the lowest price. Additionally, when selling a used vehicle, the user can seek the highest price possible. It is also a common scenario that when someone is buying a used automobile from an individual seller, the buyer can acquire the used vehicle at a much lower price than buying from an automobile dealer considering the profit margin of the dealer in the transitional transaction. Similarly, when a user is selling a used vehicle, the used vehicle can fetch a better value when the sale is made to an individual buyer than an automobile dealer as the automobile dealer would try and acquire the vehicle at a lower price and add his/her profit margin during the transitional sale. However, individual users may not have the information to maximize their quoted prices to offer their used vehicle at. Additionally, a buying non-professional user may not have sufficient information to determine a reasonable price to purchase a used vehicle.

### SUMMARY OF THE INVENTION

A method for implementing a credit risk assessment for used vehicle financing comprising: identifying a set of distinct factors of the vehicle, wherein the set of distinct factors are used to assess the credit worthiness of a transaction; grouping distinct factors of the vehicle into a bucket, wherein each bucket further roles up to group; determining a weighted average of the score of rules defines the score of the bucket; determining a weighted average of a score of bucket; defining the score of Group; calculating an overall score of the transaction; enabling a lender to implement specified combinations of overall scores and select a score; and fixing a risk appetite at any level.

### BRIEF DESCRIPTION OF THE DRAWINGS

FIG. 1 illustrates an example process for implementing a credit risk assessment for used vehicle financing, according to some embodiments.

FIG. 2 illustrates another example process for implementing a credit risk assessment for used vehicle financing, according to some embodiments.

FIG. 3 illustrates an example logical structure for Bucket, Group and Rules, according to some embodiments.

FIG. 4 illustrates an example illustrative diagram showing one sample snapshot, according to some embodiments.

FIG. 5 is a block diagram of a sample computing environment that can be utilized to implement various embodiments.

The Figures described above are a representative set and are not an exhaustive with respect to embodying the invention.

### DESCRIPTION

Disclosed are a system, method, and article of manufacture for a credit risk assessment for used vehicle financing. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment;’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment;’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Weighted average is the average of values which are scaled by importance. The weighted average of values is the sum of weights times values divided by the sum of the weights.

### Example Methods and Systems

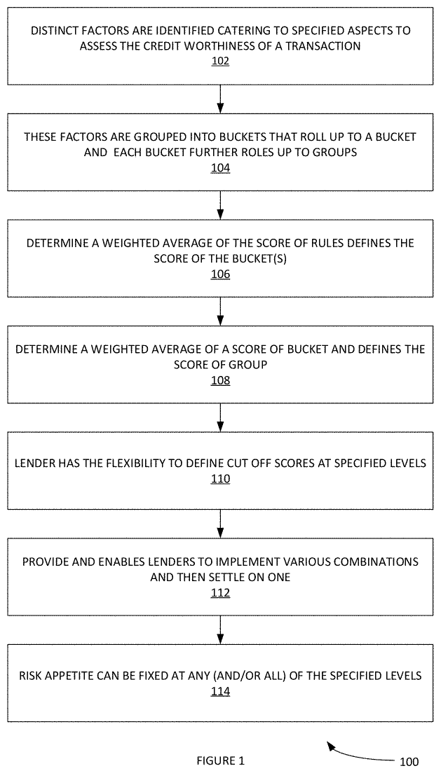

FIG. 1 illustrates an example process 100 for implementing a credit risk assessment for used vehicle financing, according to some embodiments. In step 102, distinct factors are identified. These distinct factors can cater to the following aspects to assess the credit worthiness of a transaction, inter alia: seller identity; borrower identity (e.g. profile, employment, financial standing, etc.) vehicle identity (e.g. pricing, vehicle category, etc.); other market specific factors; etc. In step 104, these factors are grouped into buckets that roll up to a Bucket. Each bucket further roles up to Groups (e.g. see infra). In step 106, process 100 determines a weighted average of the score of rules defines the score of the Bucket(s). In step 108, process 100 determines a weighted average of a score of Bucket and defines the score of Group. This further rolls up to calculate the overall Score of the transaction. In step 110, a lender (e.g. the entity that gives away loan) has the flexibility to define cut off scores at following four levels. These levels can be: Rule Level (e.g. for individual factors); Bucket Level; Group Level; and Overall Score Level. In step 112, process 100 provides and enables Lenders to implement various combinations (e.g. based on their risk appetite) and then settle on one. In step 114, the risk appetite can be fixed at any (and/or all) of the four levels.

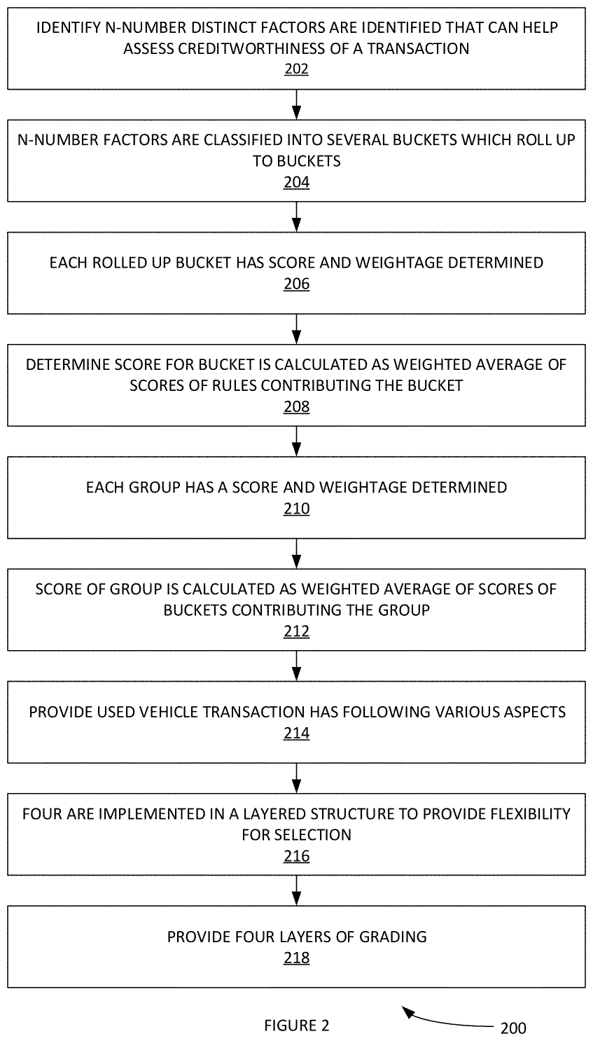

FIG. 2 illustrates another example process 200 for implementing a credit risk assessment for used vehicle financing, according to some embodiments. In step 202, process 200 can identify n-number (e.g. 55, etc.) distinct factors are identified that can help assess creditworthiness of a transaction. In step 204, the n-number (e.g. 55, etc.) factors (e.g. rules) are classified into several buckets which roll up to buckets. Each factor (rule) has a score and weightage. Each rule has an associated weightage. Each rule has configuration settings that define the method how scores can be provided to the rules. The score is provided to the rule based on the input that the rule/factor gets in each individual application.

In step 206, each rolled up bucket has score and weightage determined. In step 208, the score for bucket is calculated as weighted average of scores of rules contributing the bucket. In step 210, each Group has a score and weightage determined. In step 212, the Score of Group is calculated as weighted average of scores of buckets contributing the Group. In step 214, a used vehicle transaction has following various (e.g. five) aspects, including , inter alia: Borrower, Vehicle, Seller, Pricing, Category specific details, etc. In step 216, the four gradings are implemented in a layered structure to provide flexibility for selection. In step 218, process 200 provides four layers of grading.

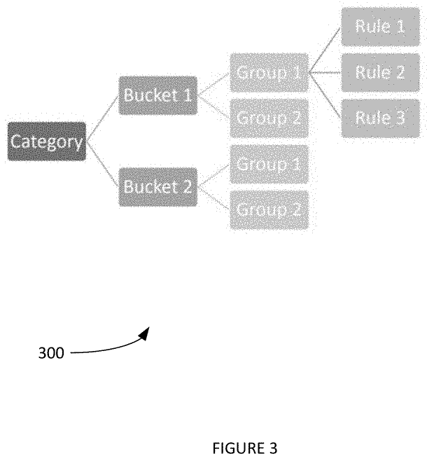

FIG. 3 illustrates an example logical structure 300 for Bucket, Group and Rules, according to some embodiments.

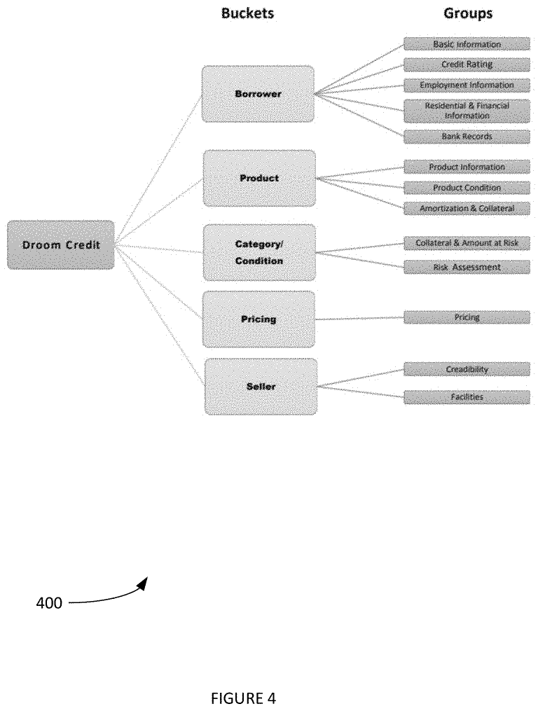

FIG. 4 illustrates an example illustrative diagram showing one sample snapshot 400, according to some embodiments.

### Additional Example Computer Architecture and Systems

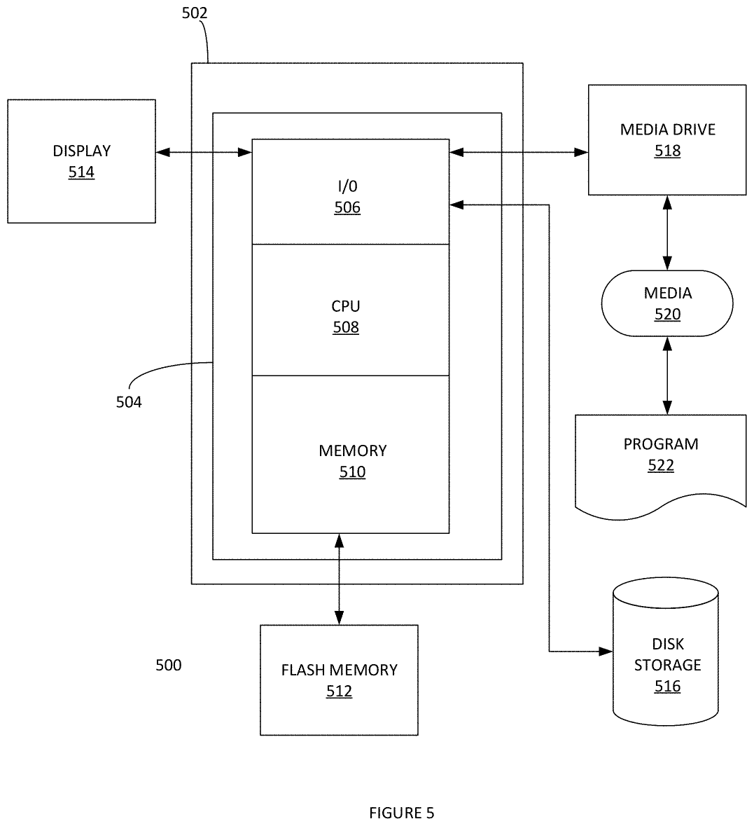

FIG. 5 depicts an exemplary computing system 500 that can be configured to perform any one of the processes provided herein. In this context, computing system 500 may include, for example, a processor, memory, storage, and I/O devices (e.g., monitor, keyboard, disk drive, Internet connection, etc.). However, computing system 500 may include circuitry or other specialized hardware for carrying out some or all aspects of the processes. In some operational settings, computing system 500 may be configured as a system that includes one or more units, each of which is configured to carry out some aspects of the processes either in software, hardware, or some combination thereof.

FIG. 5 depicts computing system 500 with a number of components that may be used to perform any of the processes described herein. The main system 502 includes a motherboard 504 having an I/O section 506, one or more central processing units (CPU) 508, and a memory section 510, which may have a flash memory card 512 related to it. The I/O section 506 can be connected to a display 514, a keyboard and/or other user input (not shown), a disk storage unit 516, and a media drive unit 518. The media drive unit 518 can read/write a computer-readable medium 520, which can contain programs 522 and/or data. Computing system 500 can include a web browser. Moreover, it is noted that computing system 500 can be configured to include additional systems in order to fulfill various functionalities. Computing system 500 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A method for implementing a credit risk assessment for used vehicle financing comprising:
identifying a set of distinct factors of the vehicle, wherein the set of distinct factors are used to assess the credit worthiness of a transaction;
grouping distinct factors of the vehicle into a bucket, wherein each bucket further roles up to group;
determining a weighted average of the score of rules defines the score of the bucket;
determining a weighted average of a score of bucket;
defining the score of Group;
calculating an overall score of the transaction;
enabling a lender to implement specified combinations of overall scores and select a score; and
fixing a risk appetite at any level.

2. The method of claim 1, wherein the set of distinct factors comprises a seller identity.

3. The method of claim 1, wherein the set of distinct factors comprises a borrower identity.

4. The method of claim 3, wherein the borrower identity comprises a borrower profile, a borrower employment identifier, and a borrower financial standing.

5. The method of claim 1, wherein the set of distinct factors comprises a vehicle identity.

6. The method of claim 5, wherein the vehicle identify comprises a vehicle pricing, and a vehicle category.

7. The method of claim 1, wherein a specified combination is based on a lender risk appetite value.
